(19) United States
(12) Patent Application Publication
(10) Pub. No.: US 2025/0173669 A1
(43) Pub. Date: May 29, 2025

(54) LOGICAL COMPOSITE DEVICES IN COMMUNICATION NETWORK INVENTORIES

(71) Applicant: AT&T Intellectual Property I, L.P., Atlanta, GA (US)

(72) Inventors: Ernest Bayha, Jackson, NJ (US); Brian Horen, Littleton, CO (US); Aaron Harris, Lenexa, KS (US)

(21) Appl. No.: 18/521,137

(22) Filed: Nov. 28, 2023

(51) Int. Cl. G06Q 10/087

(52) U.S. Cl. CPC G06Q 10/087

(57) ABSTRACT

A processing system may obtain a description of a first physical component of a logical composite device comprising at least two distributed physical components to perform a function in a communication network, where the at least two distributed physical components are dedicated to the logical composite device, and where the at least two distributed physical components include the first physical component. The processing system may next obtain a description of a second physical component of the at least two distributed physical components and add a set of one or more inventory objects representing the logical composite device to a communication network inventory database in accordance with the descriptions, where the communication network inventory database is in accordance with a class model having a plurality of classes, the plurality of classes including a logical composite class, the one or more inventory objects in accordance with the logical composite class.

The present disclosure relates generally to database system and to communication network maintenance and operations, and more specifically to apparatuses, computer-readable media, and methods for adding to a communication network inventory database one or more inventory objects representing a first logical composite device comprising at least two distributed physical components dedicated to the first logical composite device to perform a function in a communication network.

### BACKGROUND

Graph databases are useful for organizing and managing large amounts of interconnected data. The ability to easily and efficiently retrieve data from graph databases is important as these data structures gain popularity.

### SUMMARY

The present disclosure describes apparatuses, computer-readable media, and methods for adding to a communication network inventory database one or more inventory objects representing a first logical composite device comprising at least two distributed physical components dedicated to the first logical composite device to perform a function in a communication network. For instance, in one example, a processing system including at least one processor may obtain a first description of at least a first physical component of a first logical composite device. The first logical composite device may comprise at least two distributed physical components to perform a function in a communication network, where the at least two distributed physical components are dedicated to the first logical composite device, and where the at least two distributed physical components include the at least the first physical component. The processing system may next obtain a second description of at least a second physical component of the at least two distributed physical components. The processing system may then add a set of one or more inventory objects representing the first logical composite device to a communication network inventory database in accordance with the first description and the second description. The communication network inventory database may be in accordance with a class model having a plurality of classes, where the plurality of classes includes a logical composite class, and where the one or more inventory objects representing the first logical composite device are in accordance with the logical composite class.

### BRIEF DESCRIPTION OF THE DRAWINGS

The present disclosure can be readily understood by considering the following detailed description in conjunction with the accompanying drawings, in which:

FIG. 1 illustrates one example of a system related to the present disclosure;

FIG. 2 illustrates an example of a communication network inventory class model, in accordance with the present disclosure;

FIG. 3 illustrates a graph, e.g., a portion of a graph database representing an example logical composite device in accordance with the present disclosure;

FIG. 4 illustrates examples of different representations of network equipment, including logical composites, in accordance with the present disclosure;

FIG. 5 illustrates example user interfaces associated with creating and visualizing inventory objects associated with a logical composite, in accordance with the present disclosure;

FIG. 6 illustrates an example flowchart of a method for adding to a communication network inventory database one or more inventory objects representing a first logical composite device comprising at least two distributed physical components dedicated to the first logical composite device to perform a function in a communication network; and

FIG. 7 illustrates a high-level block diagram of a computing device specially programmed to perform the functions described herein.

To facilitate understanding, identical reference numerals have been used, where possible, to designate identical elements that are common to the figures.

### DETAILED DESCRIPTION

The present disclosure broadly discloses apparatuses, non-transitory (i.e., tangible or physical) computer-readable media, and methods for adding to a communication network inventory database one or more inventory objects representing a first logical composite device comprising at least two distributed physical components dedicated to the first logical composite device to perform a function in a communication network. In particular, examples of the present disclosure provide a single modeling for representing a variety of communication network equipment and software-defined components using a single modeling construct, rather than custom modeling approaches for each. In particular, examples of the present disclosure may represent an inventory object as a combination of parts and functions, such as cards and ports, grouped together to determine the physical and virtual objects and their use. For instance, a network inventory database of the present disclosure may characterize an inventory object based on an inventory object model and the highest level of capability that the inventory object can provide. In addition, a usage of the inventory object may be identified using a recipe assembly structure (e.g., a “router recipe” or the like). As such, an instance of an inventory object of the present disclosure may identify a set of parts or functions with one or more model numbers that fulfill an overall role by combining smaller modules that each have their own purpose. Thus, the conception of a network equipment is expanded beyond one physical object. Rather, in accordance with the present disclosure, the construction of a network component (e.g., an instance of an inventory object) may be based on the functions of the individual components (e.g., sub-components), thus allowing any kind of aggregate equipment to be represented. In other words, the aggregate device is viewed as an amalgamation of logical service objects (e.g., constituent physical and logical components). In one example, such an aggregate device may be referred to herein as a logical composite.

Notably, physical and logical devices may be inventoried in a top-down approach where each device has an identity which determines the functions that it performs. However, in accordance with the present disclosure, the type, role, and/or function of a device may be identified by the constituent components making up the aggregate device (i.e., constructive approach). In one example, components of the aggregate device may have respective serial numbers and the ability to alarm independently, e.g., when an abnormality occurs or is suspected. However, this creates complexity in representing the various types of network equipment/devices in a same network inventory.

For instance, in accordance with examples of the present disclosure it cannot be assumed that a single device template, e.g., comprising vendor-specific cards that can be inserted in slots of the device, is sufficient to represent the object. In one example, for an aggregate device, e.g., a logical composite, the acceptable functions can be selected from a list of approved components (e.g., base server, storage devices, controllers, etc.) to make a minimal configuration of the aggregate device functional. This modelling approach allows the use of the same structure to represent logical containerized functionality. As such, one or more data centers may provide a series of network computing resources that can be packaged into a logical composite.

Notably, examples of the present disclosure enable modeling of any type of asset or device as an amalgamation of a series of parts and functions. This approach supports the modeling of different network assets such as a router, a switch, a network cloud function, and so forth using structural templates reflecting the associated usage/function(s). For example, a network cloud function may comprise a number of distinct physical equipment instances that together have one logical identity. This enables a unified equipment modeling approach for visualizing and constructing equipment consistently across: a physical device, multiple physical devices modeled as one logical object (e.g., a logical composite), a single logical machine, multiple virtual machines modeled as one logical object, and multiple physical devices and virtual machines modeled as one logical object.

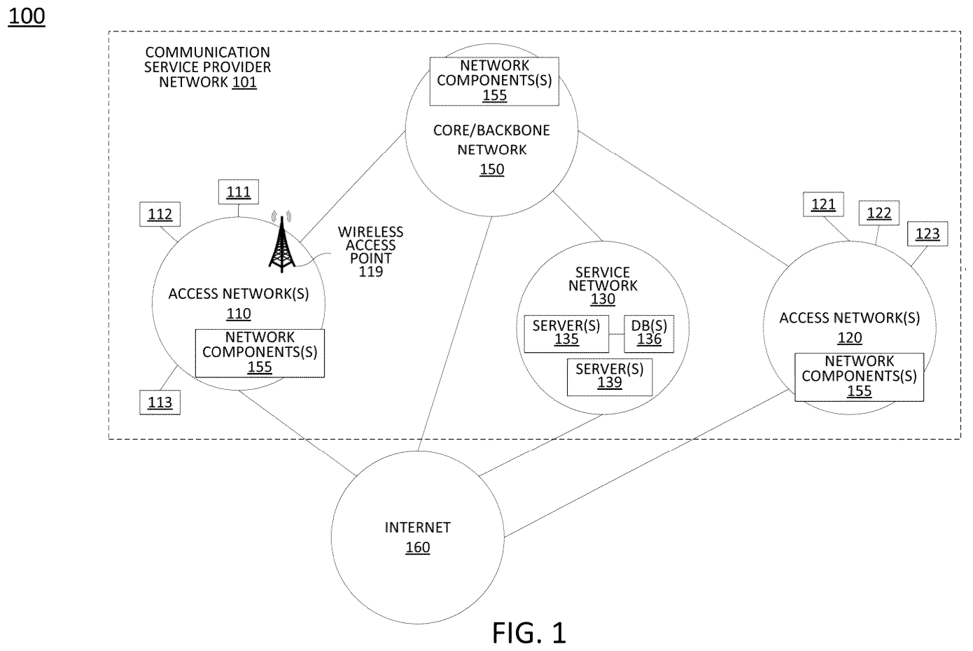

It is again noted that a logical composite represents the amalgamation of multiple components that when combined together perform the intended purpose in the infrastructure. A logical composite can be entirely made of physical components or a combination of physical components with one or more additional virtual components. This contrasts with purpose-built hardware that is designed for a specific purpose. For example, a logical composite may contain an amalgamation of cabinets and shelves comprising off-the-shelf, or commodity hardware (potentially) from different manufacturers, which when combined together along with software, perform the desired purpose. The logical composite may also have a unique name in the communication network inventory database distinct from the name of each component, and may also alarm separate from its components. In addition, the software is independent of the hardware components being used. In contrast, custom-built network equipment may contain purpose-built components from a single manufacturer, or assembled by a single vendor as an integral unit with a single, unique, alarmable name for the entire device, and where the software is dependent upon the hardware being used. These and other aspects of the present disclosure are discussed in greater detail below in connection with the examples of FIGS. 1-7.

To aid in understanding the present disclosure, FIG. 1 illustrates an example system 100 comprising a plurality of different networks in which examples of the present disclosure may operate. Communication service provider network 101 may comprise a core network and/or backbone network 150 with components for telephone services, Internet services, and/or television services (e.g., triple-play services, etc.) that are provided to customers (broadly “subscribers”), and to peer networks. In one example, core/backbone network 150 may combine core network components of a cellular network with components of a triple-play service network. For example, communication service provider network 101 may functionally comprise a fixed-mobile convergence (FMC) network, e.g., an IP Multimedia Subsystem (IMS) network. In addition, core/backbone network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VOIP) telephony services. Communication service provider network 101 may also further comprise a broadcast video network, e.g., a cable television provider network or an Internet Protocol Television (IPTV) network, as well as an Internet Service Provider (ISP) network. With respect to video/television service provider functions, core/backbone network 150 may include one or more video servers for the delivery of video content, e.g., a broadcast server, a cable head-end, a video-on-demand (VoD) server, and so forth. For example, core/backbone network 150 may comprise a video super hub office, a video hub office and/or a service office/central office.

In one example, access networks 110 and 120 may each comprise a Digital Subscriber Line (DSL) network, a broadband cable access network, a Local Area Network (LAN), a cellular or non-cellular wireless access network, and the like. For example, access networks 110 and 120 may transmit and receive communications between endpoint devices 111-113, endpoint devices 121-123, and service network 130, and between core/backbone network 150 and endpoint devices 111-113 and 121-123 relating to voice telephone calls, communications with web servers via the Internet 160, and so forth. Access networks 110 and 120 may also transmit and receive communications between endpoint devices 111-113, 121-123 and other networks and devices via Internet 160. For instance, in another example, one or both of the access networks 110 and 120 may comprise an ISP network separate from communication service provider network 101, such that endpoint devices 111-113 and/or 121-123 may communicate over the Internet 160, without involvement of the communication service provider network 101. Endpoint devices 111-113 and 121-123 may each comprise a telephone, e.g., for analog or digital telephony, a mobile device, such as a cellular smart phone, a laptop, a tablet computer, etc., a router, a gateway, a desktop computer, a plurality or cluster of such devices, a television (TV), e.g., a “smart” TV, a set-top box (STB), and the like.

In one example, the access networks 110 and 120 may be different types of access networks. In another example, the access networks 110 and 120 may be the same type of access network. In one example, one or more of the access networks 110 and 120 may be operated by the same or a different service provider from a service provider operating the communication service provider network 101. For example, each of the access networks 110 and 120 may comprise an Internet service provider (ISP) network, a cable access network, and so forth. In another example, each of the access networks 110 and 120 may comprise a cellular access network, implementing such technologies as: global system for mobile communication (GSM), e.g., a base station subsystem (BSS), GSM enhanced data rates for global evolution (EDGE) radio access network (GERAN), or a UMTS terrestrial radio access network (UTRAN) network, among others, where core/backbone network 150 may provide cellular core network functions, e.g., of a public land mobile network (PLMN)-universal mobile telecommunications system (UMTS)/General Packet Radio Service (GPRS) core network, or the like. For instance, access network(s) 110 may include at least one wireless access point (AP) 119, e.g., a cellular base station, such as an eNodeB, or gNB, a non-cellular wireless access point (AP), such as an Institute of Electrical and Electronics Engineers (IEEE) 802.11 (Wi-Fi) access point, or the like. In still another example, access networks 110 and 120 may each comprise a home network or enterprise network, which may include a gateway to receive data associated with different types of media, e.g., television, phone, and Internet, and to separate these communications for the appropriate devices. For example, data communications, e.g., Internet Protocol (IP) based communications may be sent to and received from a router in one of the access networks 110 or 120, which receives data from and sends data to the endpoint devices 111-113 and 121-123, respectively.

In this regard, it should be noted that in some examples, endpoint devices 111-113 and 121-123 may connect to access networks 110 and 120 via one or more intermediate devices, such as a home gateway and router, e.g., where access networks 110 and 120 comprise cellular access networks, ISPs and the like, while in another example, endpoint devices 111-113 and 121-123 may connect directly to access networks 110 and 120, e.g., where access networks 110 and 120 may comprise local area networks (LANs), enterprise networks, and/or home networks, and the like.

In one example, communication service provider network 101 may also include one or more network components 155 (e.g., in core/backbone network 150 and/or access network(s) 110 and 120). Network components 155 may include various physical components of communication service provider network 101. For instance, network components 155 may include various types of optical network equipment, such as an optical network terminal (ONT), an optical network unit (ONU), an optical line amplifier (OLA), a fiber distribution panel, a fiber cross connect panel, and so forth. Similarly, network components 155 may include various types of cellular network equipment, such as a mobility management entity (MME), a mobile switching center (MSC), an eNodeB, a gNB, a base station controller (BSC), a baseband unit (BBU), a remote radio head (RRH), an antenna system controller, and so forth. In one example, network components 155 may alternatively or additionally include voice communication components, such as a call server, an echo cancellation system, voicemail equipment, a private branch exchange (PBX), etc., short message service (SMS)/text message infrastructure, such as an SMS gateway, a short message service center (SMSC), or the like, video distribution infrastructure, such as a media server (MS), a video on demand (VoD) server, a content distribution node (CDN), and so forth. Network components 155 may further include various other types of communication network equipment such as a layer 3 router, e.g., a provider edge (PE) router, an integrated services router, etc., an internet exchange point (IXP) switch, and so on. In addition, network components 155 may include device housings, e.g., cabinets, racks, or the like, slots, ports, line cards, fabric providing hardware, backplanes, and so forth. In one example, network components 155 may further include virtual components, such as a virtual machine (VM), a virtual container, etc., software defined network (SDN) nodes, such as a virtual mobility management entity (vMME), a virtual serving gateway (vSGW), a virtual network address translation (NAT) server, a virtual firewall server, or the like, and so forth. It should be noted that network components 155 may include a physical device, multiple physical devices modeled as one logical object (e.g., a logical composite), a single logical machine, multiple virtual machines modeled as one logical object, and multiple physical devices and virtual machines modeled as one logical object. In addition, for ease of illustration, various components of communication service provider network 101 are omitted from FIG. 1.

In one example, the service network 130 may comprise a local area network (LAN), or a distributed network connected through permanent virtual circuits (PVCs), virtual private networks (VPNs), and the like for providing data and voice communications. In one example, the service network 130 may comprise one or more devices for providing services to subscribers, customers, and/or users. For example, communication service provider network 101 may provide a cloud storage service, web server hosting, and other services. As such, service network 130 may represent aspects of communication service provider network 101 where infrastructure for supporting such services may be deployed. In one example, the service network 130 may alternatively or additionally comprise one or more devices supporting operations and management of communication service provider network 101. For instance, in the example of FIG. 1, server(s) 139 may include higher level services/applications such as a database of assigned telephone numbers, a database of basic customer account information for all or a portion of the customers/subscribers of the communication service provider network 101, a billing system, a customer relationship management (CRM) system, a trouble ticket system, an ordering system, an enterprise reporting system (ERS), an account object (AO) database system, and so forth.

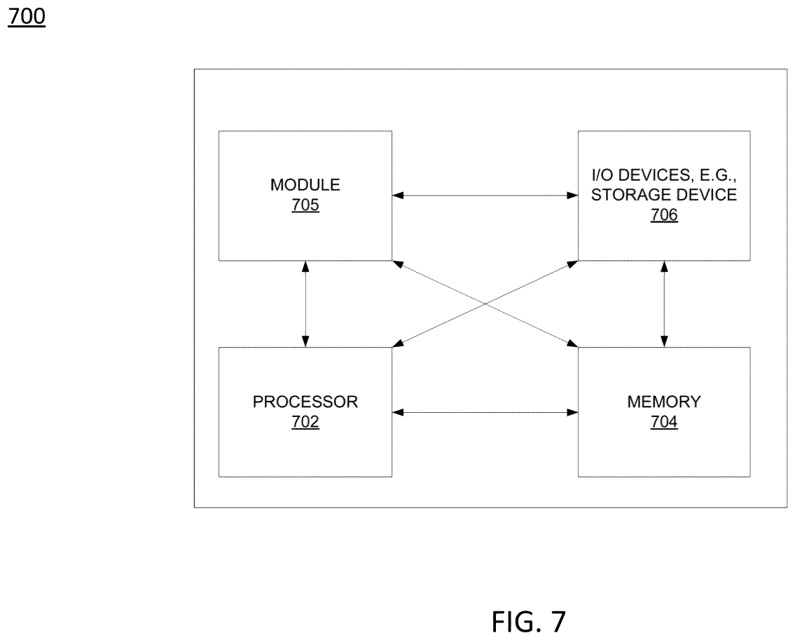

In addition, service network 130 may include one or more servers 135 which may each comprise all or a portion of a computing device or system, such as computing system 700, and/or processing system 702 as described in connection with FIG. 7 below, specifically configured to perform various steps, functions, and/or operations for adding to a communication network inventory database one or more inventory objects representing a first logical composite device comprising at least two distributed physical components dedicated to the first logical composite device to perform a function in a communication network, as described herein. For example, one of the server(s) 135, or a plurality of servers 135 collectively, may perform operations in connection with the example method 600, or as otherwise described herein.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 7 and discussed below) or multiple computing devices collectively configured to perform various steps, functions, and/or operations in accordance with the present disclosure.

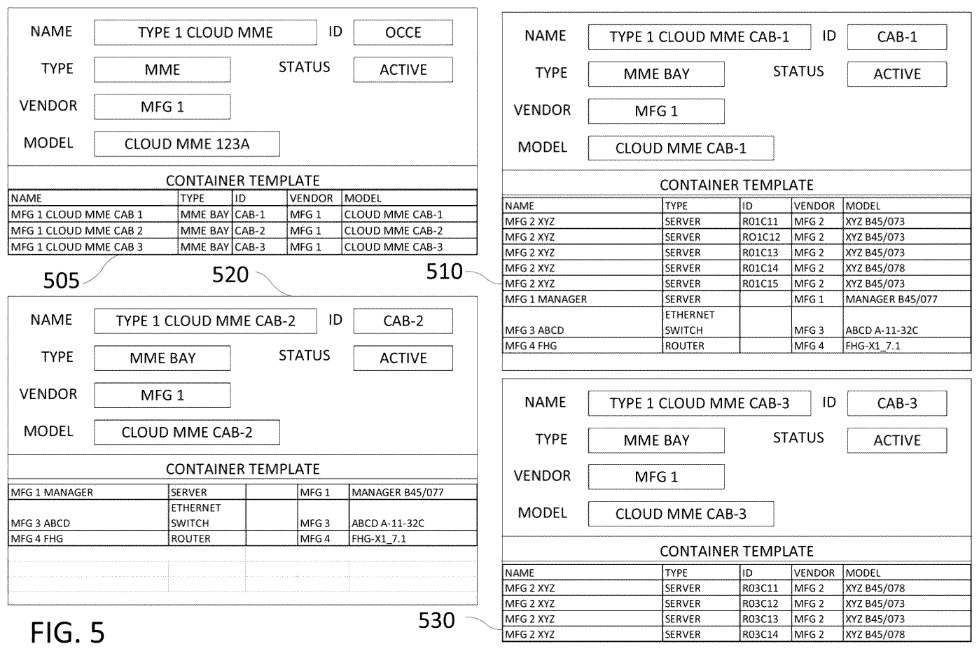

In one example, service network 130 may also include one or more databases (DBs) 136, e.g., physical storage devices integrated with server(s) 135 (e.g., database servers), attached or coupled to the server(s) 135, and/or in remote communication with server(s) 135 to store various types of information in connection with examples of the present disclosure. As just one example, DB(s) 136 may be configured to receive and store information of a communication network inventory, e.g., a telecommunication network inventory (TNI), or TNI database. For instance, example inventory object records are illustrated in example user interface views of FIG. 5 and described in greater detail below.

In one example, server(s) 135 and/or DB(s) 136 may comprise cloud-based and/or distributed data storage and/or processing systems comprising one or more servers at a same location or at different locations. For instance, DB(s) 136, or DB(s) 136 in conjunction with one or more of the servers 135, may represent a distributed file system, e.g., a Hadoop® Distributed File System (HDFS™), or the like. In one example, the one or more of the servers 135 and/or server(s) 135 in conjunction with DB(s) 136 may comprise a communication network inventory platform (e.g., a network-based and/or cloud-based service hosted on the hardware of server(s) 135 and/or DB(s) 136).

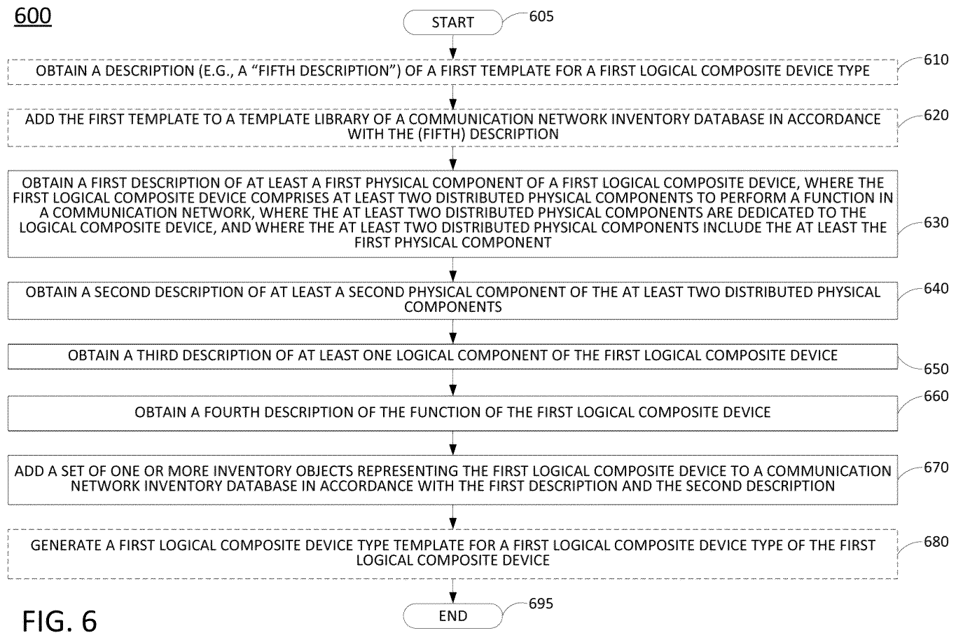

As noted above, server(s) 135 may be configured to perform various steps, functions, and/or operations for adding to a communication network inventory database one or more inventory objects representing a first logical composite device comprising at least two distributed physical components dedicated to the logical composite device to perform a function in a communication network, as described herein. For instance, an example method for adding to a communication network inventory database one or more inventory objects representing a first logical composite device comprising at least two distributed physical components dedicated to the first logical composite device to perform a function in a communication network is illustrated in FIG. 6 and described in greater detail below. Servers(s) 135 may alternatively or additionally perform various operations as described in connection with FIGS. 1-5, or elsewhere herein.

In addition, it should be realized that the system 100 may be implemented in a different form than that illustrated in FIG. 1, or may be expanded by including additional endpoint devices, access networks, network elements, application servers, etc. without altering the scope of the present disclosure. As just one example, any one or more of server(s) 135 and DB(s) 136 may be distributed at different locations, such as in or connected to access networks 110 and 120, in another service network connected to Internet 160 (e.g., a cloud computing provider), in core/backbone network 150, and so forth. Thus, these and other modifications are all contemplated within the scope of the present disclosure.

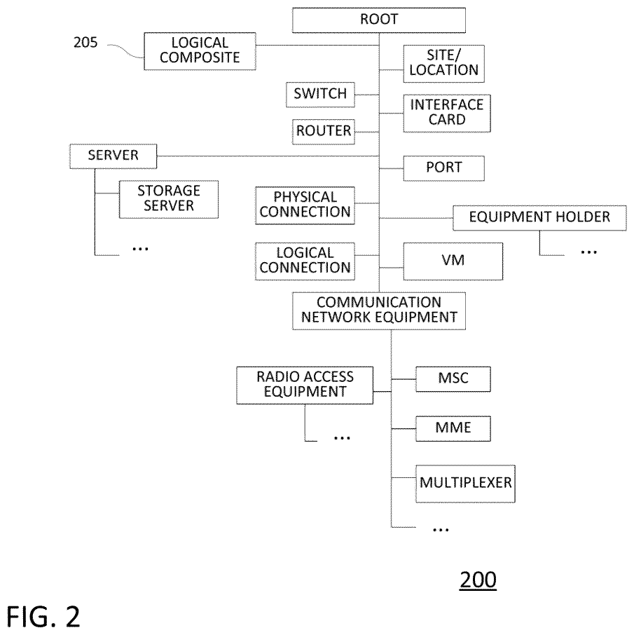

FIG. 2 illustrates an example of a communication network inventory class model 200, in accordance with the present disclosure. In particular, as described herein, logical composites may be represented as a class/object type in a communication network inventory database (CNID) (e.g., logical composite class 205). In one example, a CNID may be part of a configuration management database (CMDB) under a hierarchical class of “communication network equipment” or “telecommunication network equipment.” For instance, an example hierarchical communication network inventory class model 200 is shown in FIG. 2. To further illustrate, the communication network inventory class model 200 may include a general class of “root” having various sub-classes of: site/location, switch, router, interface card, port, server, equipment holder, network circuit, application, virtual machine (VM), physical connection, logical connection, communication network equipment, and logical composite 205. Various classes/sub-classes may also have sub-classes thereof. For instance, “communication network equipment” may be further categorized as: a mobility management entity (MME) class, a mobile switching center (MSC) class, a multiplexer class, a radio access equipment class, and so forth. Similarly, “server” may be further categorized as “storage server”, etc. In addition, it should be noted that the example of FIG. 2 is just one example of a hierarchical communication network inventory class model 200, and that other, further, and different network inventory class models may be utilized in connection with examples of the present disclosure. For example, the communication network inventory class model 200 may be expanded to include additional classes and/or sub-classes, a single class in the present communication network inventory class model 200 may be split into two or more classes, one or more classes may be omitted, two or more classes may be combined, one or more may be sub-classes of a different class than illustrated in FIG. 2, and so forth. To further illustrate, in one example, “equipment holder” may have sub-classes of “cabinet”, “rack”, “slot”, “shelf”, etc. Similarly, “server” may have additional sub-classes of “media server”, “voicemail server”, or the like. Alternatively, these classes may instead be sub-classes of “communication network equipment”. Thus, these and other modifications are all contemplated within the scope of the present disclosure.

In one example, each class may have a class template that defines the type, role, and/or function of the class, the sub-classes (if any) of the class, and additional characteristics of the class and/or devices thereof. In addition, for various classes there may be associated device type templates for different instances of devices within the class, e.g., for a first router type of a first manufacturer, a second router type of the first manufacturer, a first router type of a second manufacturer, a second router type of the second manufacturer, a first interface card type of the first manufacturer, a first interface card type of a third manufacturer, and so on. An example of an inventory object for a logical composite that may be in accordance with a logical composite class template and/or logical composite device type template is illustrated in FIG. 5 and described in greater detail below.

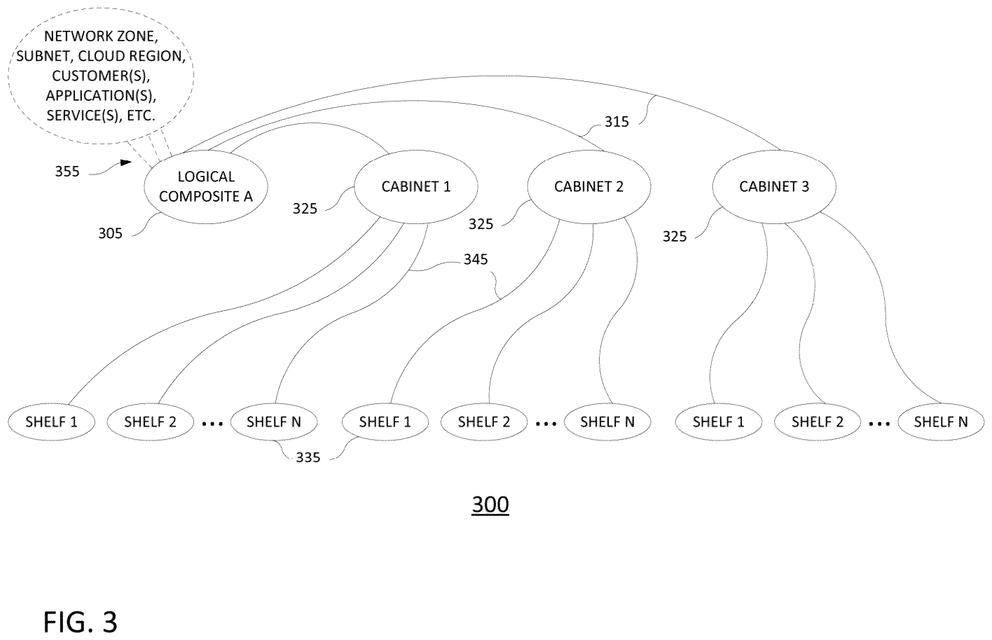

To further aid in understanding the present disclosure, FIG. 3 illustrates a graph 300, e.g., a portion of a graph database representing an example logical composite device (broadly, a “logical composite”) in accordance with the present disclosure. In particular, the graph 300 may include a plurality of inventory objects (e.g., nodes), such as node 305 for “logical composite A” (e.g., a particular instance of a logical composite device of a given type), having relationships, e.g., edges 315 indicating components of logical composite A (e.g., cabinets 1-3, represented by inventory objects 325). In addition, cabinets 1-3 may have additional sub-components thereof (e.g., shelves 1-N for each of the respective cabinets 1-3) indicated by additional edges 345 connected to respective inventory objects 335 representing various shelves. It should be noted that for ease of illustration, only some of the edges 315 and 345, and only some of the inventory objects 335 are specifically labeled in FIG. 3. In accordance with the present disclosure, each of the edges 315 may represent a “component of” relationship between inventory objects (e.g., between the logical composite A and the cabinets 1-3 represented by the respective inventory objects). Similarly, each of the edges 345 may represent an “is contained by” relationship between inventory objects (e.g., between the cabinets and shelves represented by the respective inventory objects).

In one example, the graph 300 may comprise a projection or view of a larger graph/graph database that may include additional relationships and object/node types, such as personnel objects/nodes, business application objects/nodes, and operational, management, and/or security relationships (e.g., “receives alarms from,” “managed by,” “created by,” “accessible by,” “configurable by,” etc.), and so forth. Thus, for example, as illustrated in FIG. 3, one or more additional edges 355 may be connected to the inventory object 305 representing logical composite A indicating these additional relationships that may exist in various examples. As just one example, logical composite A may function as a firewall assigned to a particular network zone, e.g., where other firewall devices, whether single instance devices or other logical composites, may be assigned to other network zones, and so forth.

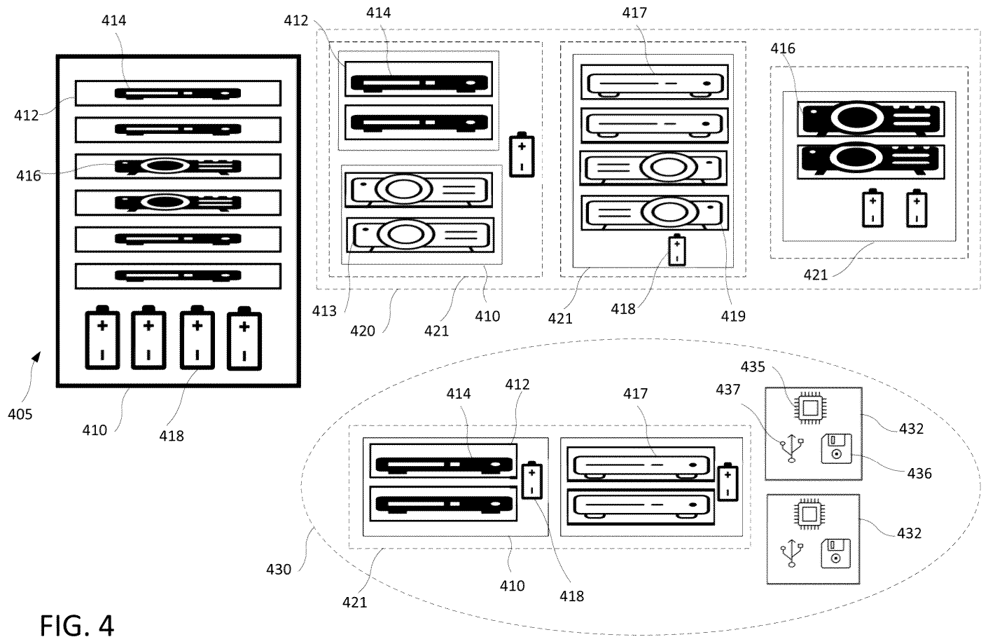

FIG. 4 illustrates examples of different representations of network equipment in accordance with the present disclosure. For instance, a first example illustrates a single physical device 405 having a chassis 410 with a number of shelves 412, where each shelf 412 holds a sub-component, such as a linecard 414 or route processor 416. In addition, the physical device 405 may include several power supplies 418. It should be noted that for ease of illustration, not all of the shelves 412, linecards 414, route processors 416, or power supplies 418 are specifically labeled in FIG. 1. Nevertheless, it should be understood that similarly illustrated aspects of FIG. 1 may represent the same or similar element types. In addition, it should be noted that the components of the single physical device 405 may be purpose-built components from a single manufacturer, or assembled by a single vendor as an integral unit with a single, unique, alarmable name for the entire physical device 405.

In contrast to a single physical device, such as physical device 405, FIG. 4 further illustrates a first example logical composite 420. It should be noted that various components of logical composite 420 may be the same or similar to components of physical device 405. However, components of logical composite 420 may be at different sites 421 and/or located/installed in different chassis/racks 410 (or different cabinets). The example logical composite 420 includes additional component types of a port to fabric switching hardware 413, a control and management providing hardware 417, and a fabric providing hardware 419. In addition to having distributed components (e.g., different chassis/racks/cabinets and/or different sites), the components of logical composite 420 may be from a plurality of different manufacturers/vendors, where one or more vendor/manufacturer components may interchangeable perform one or more functions of the logical composite 420. For instance, the route processors 416 of logical composite 420 may be different makes/models, but may be functional equivalents. Likewise, one or both of route processors 416 may be swapped for another functional equivalent (e.g., a different make and/or model capable of and/or configurable to perform the same functions), while the logical composite 420 may provide the same overall functions when deployed in a communication network.

FIG. 4 further illustrates a second example logical composite 430 including various distributed hardware components, e.g., linecards 414, control and management providing hardware 417, power supplies 418, etc. in different chassis/racks 410 (or cabinets). However, logical composite 430 further includes logical components, e.g., virtual machines (VMs) 432. For instance, each of the VMs 432 may include processing resources (e.g., one or more processors, such as central processing units (CPUs), graphics processing units (GPUs), or the like), memory resources 436, input/output resources 437, and so on. It should be noted that VMs 432 may be instantiated and reside on different network infrastructure at different times. For instance, hardware hosting one of the VMs 432 may have reduced utilization and a software defined network (SDN) controller may determine to deactivate the hardware and reassign the one of the VMs 432 to different hardware resources. Thus, VMs 432 may be associated with different hardware and/or different sites at different times. In contrast, the hardware resources, e.g., linecards 414, control and management providing hardware 417, power supplies 418, etc. of logical composite 430 are dedicated to logical composite 430 (e.g., and are not reconfigurable and reassignable to other devices or systems, such as by an SDN controller or the like). Similarly, the hardware resources of the first example logical composite 420 are also not reconfigurable and reassignable to other devices or systems, such as by an SDN controller or the like.

FIG. 5 illustrates example user interfaces associated with creating and visualizing inventory objects associated with a logical composite, in accordance with the present disclosure. For instance, a logical composite may be in accordance with a logical composite device type template for logical composite of a particular type, e.g., “Cloud MME” in the example of FIG. 5 (e.g., a “cloud” mobility management entity (MME)). A first user interface view 505 may include inventory object data regard the logical composite such as the name, device type, vendor, model, identifier (ID), and status. It should be noted that in the present example, the vendor field is populated with “MFG 1” (Manufacturer 1). However, it should be noted that in other examples, a logical composite may be arranged by a network operator independent of any particular manufacturer, in which case, the vendor field may be left blank, or the network operator may identify itself in this field. As further illustrated in the example screen 505, hierarchical subcomponents of the type 1 Cloud MME are listed in a table of sub-components, e.g., cabinets 1-3 (CAB-1, CAB-2, CAB-3). For instance, these sub-components may have a “component of” relationship to the logical composite itself (e.g., such as represented by edges 315 in the example of FIG. 3).

In one example, additional view 510, 520, and 530 may be provided for more detailed information regarding the type, role, function (TRF) and/or additional components of cabinets 1-3, respectively. For instance, view 510 identifies additional information regarding cabinet 1, including the name, type (e.g., MME bay), and so forth. In accordance with a container template for “MME bay,” sub-components of cabinet 1 are further listed. To illustrate, cabinet 1 may contain five servers, a management entity (e.g., manager model no. B45/077), an Ethernet switch, and a router, respectively. As noted above, each device is separately alarmable and type-role-function (TRF) may be defined for each of the five different device types (e.g., server with model type XYZ B45/073, server with model type XYZ B45/078, server with model type Manager B45/077, Ethernet switch with model type ABCD A-11-32C, and router with model type FHG-X1_7.1). Similarly, view 520 illustrates that cabinet 2 may comprise five devices with four different types (e.g., server with model type XYZ B45/078, server with model type Manager B45/077, Ethernet switch with model type ABCD A-11-32C, and router with model type FHG-X1_7.1). Lastly, view 530 illustrates that cabinet 3 may comprise four devices with two different types (e.g., server with model type XYZ B45/073 and server with model type XYZ B45/078). Thus, the logical composite is a container comprising three cabinets, where each cabinet is an equipment holder containing devices (e.g., in shelves or the like), and where TRF values are defined on the logical composite (and the different device types within the cabinets 1-3 thereof).

It should be noted that a logical composite in accordance with the present disclosure may include at least two distinct hardware components that are not part of the same cabinet/chassis/rack (e.g., in different cabinets/chassis/racks at a same site or at different sites) and that are dedicated to the logical composite (e.g., which are not shared with any other network elements and which cannot be reconfigured and/or reassigned, such as by an SDN controller, a VM orchestrator, a VM manager, or the like). However, it should be noted that a logical composite may further comprise one or more virtual components, such as a VM, a container, or the like, which may be instantiated on shared hardware. In other words, such virtual component(s) may be optionally included in a logical composite, e.g., in addition to the at least two distributed, dedicated hardware components. Thus, these and other modifications are all contemplated within the scope of the present disclosure.

FIG. 6 illustrates a flowchart of an example method 600 for adding to a communication network inventory database one or more inventory objects representing a first logical composite device comprising at least two distributed physical components dedicated to the first logical composite device to perform a function in a communication network. In one example, steps, functions, and/or operations of the method 600 may be performed by a device as illustrated in FIG. 1, e.g., one or more of the servers 135, or the like. Alternatively, or in addition, the steps, functions and/or operations of the method 600 may be performed by a processing system collectively comprising a plurality of devices as illustrated in FIG. 1 such as one or more of the servers 135, DB(s) 136, endpoint devices 111-113 and/or 121-123, and so forth. In one example, the steps, functions, or operations of method 600 may be performed by a computing device or system 700, and/or a processing system 702 as described in connection with FIG. 7 below. For instance, the computing device 700 may represent at least a portion of a platform, a server, a system, and so forth, in accordance with the present disclosure. For illustrative purposes, the method 600 is described in greater detail below in connection with an example performed by a processing system. The method 600 begins in step 605 and may proceed to optional step 610 or to step 630.

At optional step 610, the processing system may obtain a description (e.g., a “fifth description”) of a first template for a first logical composite device type. For instance, the description of the first template may include: a first type, role, and/or function of at least a first physical component of a logical composite of the logical composite class, a second type/role/function of at least a second physical component of the logical composite, and a plurality of acceptable physical components models for selection as the at least one of: the at least the first physical component or the at least the second physical component. In one example, the first template may include at least two relationships for at least two inventory objects representing respective physical housings of the at least the first physical component and the at least the second physical component. For instance, the example view 505 of FIG. 5 may include three cabinets in accordance with a logical composite device template that includes relationships to be populated with identifications of two (or more) housings. However, it should also be noted that one example, a logical composite may not necessarily include a housing (or housings).

At optional step 620, the processing system may add the first template to a template library of a communication network inventory database in accordance with the (fifth) description. For instance, the template library may include templates for various physical device types, logical network elements (e.g., virtual machines, containers, applications/services, or the like), and logical composites as described herein. For each logical composite type, a template may define the minimum number of components necessary for the logical composite to be able to provide an intended function (e.g., to operate as an MME, a serving gateway, a packet data network gateway, a firewall, etc.). For instance, each template may include one or more acceptable physical component lists for different roles/sub-functions within the logical composite device type. In addition, for a logical composite type that may include virtual components, a template may further define minimum compute resources to support the logical composite, acceptable software versions, and so on.

At step 630, the processing system obtains a first description of at least a first physical component of a first logical composite device, where the first logical composite device comprises at least two distributed physical components to perform a function in a communication network, where the at least two distributed physical components are dedicated to the first logical composite device, and where the at least two distributed physical components include the at least the first physical component. For instance, the first logical composite device may be installed by a network operator and placed into service. In one example, the installation may include placing respective physical components in different housings (e.g., different chassis, cabinets, racks or the like) and providing power and connectivity, such as connecting the respective physical components to respective power supplies and top of rack (ToR) switches. Thus, in one example, the at least two distributed physical components are installed in at least two distinct physical housings. In addition, in one example, the at least two distributed physical components may be of at least two distinct manufacturers.

The first description may include a device/component name, a device/component type, a vendor (e.g., a manufacturer or the like). In one example, the first description may further include an identifier, a status, and so forth. However, in another example, these may be assigned by the processing system. For instance, the identifier may be automatically assigned when the first logical composite device is added to the communication network inventory database. In addition, the status may be automatically set to inactive, but may be made active upon alert from one or more other automated systems, from later notifications from authorized field personnel, and so forth. In one example, the obtaining of the first description may be via a user interface, such as any of the views illustrated in FIG. 5, or the like. For instance, a user may select the first template from the template library. In addition, the user may select two or more housings from a list of acceptable housings for the first logical composite type. In addition, for each housing, the user may select one or more components from a list of acceptable component model types (e.g., acceptable linecards, acceptable route processors, etc.).

At step 640, the processing system obtains a second description of at least a second physical component of the at least two distributed physical components. For instance, step 640 may comprise the same or similar operations as step 630, but with respect to the second physical component, which has a distinct physical housing that is different from that of the first physical component. The second physical component may be of a same device/component type as the first physical component or may be of different device/component type.

At optional step 650, the processing system may obtain a third description of at least one logical component of the first logical composite device. In other words, the first logical composite device may further comprise as least one logical component. For instance, the at least one logical component may comprise a virtual machine, a virtual container, and/or a software component (e.g., a software version or the like). In one example, the obtaining of the third description may be via a user interface, such as any of the views illustrated in FIG. 5, or the like. For instance, a user may select the logical component(s) from one or more lists of one or more acceptable logical component types (e.g., acceptable software versions, acceptable VM and/or container types, etc.). However, it should be noted that in one example, a representation of the first logical composite device may be added to a communication network inventory database without having a specific logical composite device type template. For instance, in such case, a representation of the first logical composite device may be generated using a logical composite class template (e.g., for the logical composite class as a whole). For example, such a template may specify, at a minimum, that there are at least two distributed physical components having at least two distinct housings (but may not have any particular lists of permitted device model types, and so forth).

At optional step 660, the processing system may obtain a fourth description of the function of the first logical composite device. For instance, the function may comprise a function of a cellular network component such as an MME (e.g., a CMME), a packet data network gateway (PGW), a serving gateway (SGW), a base station (e.g., a gNodeB, eNodeB, etc.), a base station controller, a baseband unit, etc. Similarly, in another example, the function may comprise that of: a media gateway, a media server, a firewall, a router, an optical networking unit (ONU), and so forth. Thus, in one example, the function of the logical composite device may be input and obtained by the processing system at optional step 660. It should be noted that in some instances, a logical composite device may have a function that corresponds to similar single instance physical devices (e.g., a standalone firewall device, a standalone SGW or PGW, a standalone ONU, etc.). However, in other examples, a logical composite device may have hybrid functions, or different functions that do not correspond to any singular physical device types. For instance, a logical composite may comprise an amalgamation of components to provide functions of both a media gateway and a small cell radio gateway, or the like. In another example, a logical composite may comprise an amalgamation of components to provide functions of both a residential gateway and ONT, and so forth. In one example, optional step 660 may be omitted. For instance, if a representation of the first logical composite is being created using the first template from optional steps 610 and 620, the template may already contain the information specifying the type/role/function of the first logical composite. However, if a representation of the first logical composite device is being added to a communication network inventory database without using such a template, then at optional step 660 the processing system may obtain the description of the function of the first logical composite device.

At step 670, the processing system adds a set of one or more inventory objects representing the first logical composite device to a communication network inventory database in accordance with the first description and the second description. In one example, the one or more inventory objects representing the first logical composite device that are added to the communication network inventory database may be further based on the third description of the at least one logical component of optional step 650. For instance, the communication network inventory database may be in accordance with a class model having a plurality of classes, where the plurality of classes includes a logical composite class, and where the one or more inventory objects representing the first logical composite device are in accordance with the logical composite class. For instance, illustrated in the example of FIG. 3 and as described above, a logical composite may be represented by an inventory object for the logical composite itself, as well as one or more inventory objects for sub-components thereof, such as cabinets, shelves (the components installed and in operation on such shelves, etc.), and so forth. In one example, the set of one or more inventory objects representing the first logical composite device may be in accordance with the first template for the first logical composite device type. In addition, the set of one or more inventory objects representing the first logical composite device may remain in the communication network inventory database in response to a detected failure associated with the first logical composite device. In other words, the components of the first logical composite device are dedicated to the first logical composite device and are not returned to a pool of shared resources and are not reassignable, e.g., by an SDN controller or the like.

In one example, the communication network inventory database may comprise a graph database with relationships defining a plurality of edges between a plurality of inventory objects. As such, in one example, step 670 may further include adding one or more relationships, e.g., edges, to the communication network inventory database representing associations among the first logical composite and components thereof, and/or between the components, one or more relationships of the first logical composite to other network inventory items, such as network zones, subnets, applications or services supported by the first logical composite, and so forth. It should be noted that in one example, the network inventory database may include a plurality inventory objects representing a plurality of logical composite devices, where each logical composite device of the plurality of logical composite devices is of the logical composite class. However, at least some of the logical composite devices may be of different logical composite device types (which may have different logical composite device type templates in accordance with a logical composite class template). It should also be noted that the at least two distributed physical components of the first logical composite device may have unique identifiers that are separately alarmable. In addition, the first logical composite device may be alarmable distinct from the at least two distributed physical components.

At optional step 680, the processing system may generate a first logical composite device type template for a first logical composite device type of the first logical composite device. In addition, in one example, the first template may define the minimum number of components necessary for the logical composite to be able to provide an intended function (e.g., to operate as an MME, a serving gateway, a packet data network gateway, a firewall, etc.). For instance, each template may include one or more acceptable physical component lists for different roles/sub-functions within the logical composite device type. In addition, for a logical composite that may include virtual components, the template may further define minimum compute resources to support the logical composite, acceptable software versions, and so on. It should be noted that optional step 680 may be performed when the first logical composite device may be a first logical composite device to be added to the communication network as a new logical composite device type. In such case, steps 630-660 may include obtaining acceptable component lists (e.g., in addition to identifications of the particular component model types, software version(s), etc. that are deployed for the actual instance of the first logical composite device). Accordingly, the first template may then be reused as a second and subsequent logical composite devices of the first logical composite device type that are added to the communication network (and where corresponding inventory object sets may be added to the communication network inventory database).

Following step 670, or optional step 680, the method 600 ends in step 695. It should be noted that method 600 may be expanded to include additional steps, or may be modified to replace steps with different steps, to combine steps, to omit steps, to perform steps in a different order, and so forth. For instance, in one example, the processing system may repeat one or more steps of the method 600, such as steps 630-670 for additional logical composite devices of the first logical composite device type, steps 610-670, steps 630-670, or steps 630-680 for one or more additional logical composites of different logical composite device types, and so forth. In one example, an apparatus comprising the processing system may further include at least one storage component storing the communication network inventory database, e.g., a database system comprising one or more hard drives, solid state drives, a redundant array of independent discs (RAID), or the like. In one example, the method 600 may be expanded or modified to include steps, functions, and/or operations, or other features described above in connection with the example(s) of FIGS. 1-5, or as described elsewhere herein. Thus, these and other modifications are all contemplated within the scope of the present disclosure.

In addition, although not specifically specified, one or more steps, functions, or operations of the method 600 may include a storing, displaying, and/or outputting step as required for a particular application. In other words, any data, records, fields, and/or intermediate results discussed in the method 600 can be stored, displayed and/or outputted either on the device executing the method 600, or to another device, as required for a particular application. Furthermore, steps, blocks, functions, or operations in FIG. 6 that recite a determining operation or involve a decision do not necessarily require that both branches of the determining operation be practiced. In other words, one of the branches of the determining operation can be deemed as an optional step. In addition, one or more steps, blocks, functions, or operations of the above described method 600 may comprise optional steps, or can be combined, separated, and/or performed in a different order from that described above, without departing from the examples of the present disclosure.

FIG. 7 depicts a high-level block diagram of a computing device or processing system specifically programmed to perform the functions described herein. For example, any one or more components or devices illustrated in FIG. 1, or described in connection with the examples of FIGS. 2-5 may be implemented as the processing system 700. As depicted in FIG. 7, the processing system 700 comprises one or more hardware processor elements 702 (e.g., a microprocessor, a central processing unit (CPU) and the like), a memory 704, (e.g., random access memory (RAM), read only memory (ROM), a disk drive, an optical drive, a magnetic drive, and/or a Universal Serial Bus (USB) drive), a module 705 for adding to a communication network inventory database one or more inventory objects representing a first logical composite device comprising at least two distributed physical components dedicated to the first logical composite device to perform a function in a communication network, and various input/output devices 706, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in FIG. 7, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of FIG. 7 is intended to represent each of those multiple computing devices. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 702 can also be configured or programmed to cause other devices to perform one or more operations as discussed above. In other words, the hardware processor 702 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 705 for adding to a communication network inventory database one or more inventory objects representing a first logical composite device comprising at least two distributed physical components dedicated to the first logical composite device to perform a function in a communication network (e.g., a software program comprising computer-executable instructions) can be loaded into memory 704 and executed by hardware processor element 702 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 705 for adding to a communication network inventory database one or more inventory objects representing a first logical composite device comprising at least two distributed physical components dedicated to the first logical composite device to perform a function in a communication network (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. An apparatus comprising:
a processing system including at least one processor; and
a computer-readable medium storing instructions which, when executed by the processing system, cause the processing system to perform operations, the operations comprising:
obtaining a first description of at least a first physical component of a first logical composite device, wherein the first logical composite device comprises at least two distributed physical components to perform a function in a communication network, wherein the at least two distributed physical components are dedicated to the first logical composite device, wherein the at least two distributed physical components include the at least the first physical component;
obtaining a second description of at least a second physical component of the at least two distributed physical components; and
adding a set of one or more inventory objects representing the first logical composite device to a communication network inventory database in accordance with the first description and the second description, wherein the communication network inventory database is in accordance with a class model having a plurality of classes, wherein the plurality of classes includes a logical composite class, and wherein the one or more inventory objects representing the first logical composite device are in accordance with the logical composite class.

2. The apparatus of claim 1, further comprising:
at least one storage component storing the communication network inventory database.

3. The apparatus of claim 1, wherein the network inventory database includes a plurality inventory objects representing a plurality of logical composite devices, wherein each logical composite device of the plurality of logical composite devices is of the logical composite class.

4. The apparatus of claim 1, wherein the first logical composite device further comprises as least one logical component.

5. The apparatus of claim 4, wherein the operations further comprise:
obtaining a third description of the at least one logical component of the first logical composite device, wherein the one or more inventory objects representing the first logical composite device that are added to the communication network inventory database are further based on the third description of the at least one logical component.

6. The apparatus of claim 4, wherein the at least one logical component comprises at least one of:
a virtual machine; or
a virtual container.

7. The apparatus of claim 1, wherein the function comprises a function of a cellular network component.

8. The apparatus of claim 1, wherein the at least two distributed physical components are installed in at least two distinct physical housings.

9. The apparatus of claim 1, wherein the at least two distributed physical components are of at least two distinct manufacturers.

10. The apparatus of claim 1, wherein the at least two distributed physical components have unique identifiers that are separately alarmable.

11. The apparatus of claim 10, wherein the first logical composite device is alarmable distinct from the at least two distributed physical components.

12. The apparatus of claim 1, wherein the communication network inventory database comprises a graph database with relationships defining a plurality of edges between a plurality of inventory objects.

13. The apparatus of claim 1, wherein the set of one or more inventory objects representing the first logical composite device is in accordance with a first template for a first logical composite device type.

14. The apparatus of claim 13, wherein the first template defines a plurality of acceptable physical components for selection as at least one of: the at least the first physical component or the at least the second physical component.

15. The apparatus of claim 13, wherein the operations further comprise:
obtaining a fifth description of the first template; and
adding the first template to a template library of the communication network inventory database in accordance with the fifth description.

16. The apparatus of claim 14, wherein the fifth description of the first template describes:
a first role of the at least the first physical component;
a second role of the at least the second physical component; and
the plurality of acceptable physical components for selection as the at least one of: the at least the first physical component or the at least the second physical component.

17. The apparatus of claim 13, wherein the first template includes at least two relationships for at least two inventory objects representing respective physical housings of the at least the first physical component and the at least the second physical component.

18. The apparatus of claim 1, wherein the set of one or more inventory objects representing the first logical composite device remains in the communication network inventory database in response to a detected failure associated with the first logical composite device.

19. A non-transitory computer-readable medium storing instructions which, when executed by a processing system including at least one processor, cause the processing system to perform operations, the operations comprising:
obtaining a first description of at least a first physical component of a first logical composite device, wherein the first logical composite device comprises at least two distributed physical components to perform a function in a communication network, wherein the at least two distributed physical components are dedicated to the first logical composite device, wherein the at least two distributed physical components include the at least the first physical component;
obtaining a second description of at least a second physical component of the at least two distributed physical components; and
adding a set of one or more inventory objects representing the first logical composite device to a communication network inventory database in accordance with the first description and the second description, wherein the communication network inventory database is in accordance with a class model having a plurality of classes, wherein the plurality of classes includes a logical composite class, and wherein the one or more inventory objects representing the first logical composite device are in accordance with the logical composite class.

20. A method comprising:
obtaining, by a processing system including at least one processor, a first description of at least a first physical component of a first logical composite device, wherein the first logical composite device comprises at least two distributed physical components to perform a function in a communication network, wherein the at least two distributed physical components are dedicated to the first logical composite device, wherein the at least two distributed physical components include the at least the first physical component;
obtaining, by the processing system, a second description of at least a second physical component of the at least two distributed physical components; and
adding, by the processing system, a set of one or more inventory objects representing the first logical composite device to a communication network inventory database in accordance with the first description and the second description, wherein the communication network inventory database is in accordance with a class model having a plurality of classes, wherein the plurality of classes includes a logical composite class, and wherein the one or more inventory objects representing the first logical composite device are in accordance with the logical composite class.
